(19) United States
(12) Patent Application Publication
(10) Pub. No.: US 2009/0052163 A1
(43) Pub. Date: Feb. 26, 2009

(54) BACK LIGHT DEVICE

(75) Inventors: Yasuhiro Watanabe, Ehime-ken (JP); Tatsuya Ikeda, Ehime-ken (JP)

Correspondence Address: BANNER & WITCOFF, LTD., 1100 13th STREET, N.W., SUITE 1200, WASHINGTON, DC, 20005-4051, US

(73) Assignee: HARISON TOSHIBA LIGHTING CORPORATION, Imabari-shi (JP)

(21) Appl. No.: 11/914,012

(22) PCT Filed: Jan. 27, 2006
(86) PCT No.: PCT/JP2006/301323

§ 371 Date: Nov. 9, 2007

(30) Foreign Application Priority Data
May 12, 2005 (JP) 2005-139645
Aug. 2, 2005 (JP) 2005-223931

(51) Int. Cl. G02F 1/13357

(52) U.S. Cl. 362/97.2

(57) ABSTRACT

In a back light device 10 according to the present invention, a long and flat fluorescent lamp 11 with a flat shaped cross section has a major axis and a minor axis having different lengths to each other. A light incident plane 121a of a light guide plate 12 is formed in a light emitting area of the light guide plate. A light incident plane and a major axis light emitting plane of the flat fluorescent lamp are arranged to be facing to each other. With the structure, the back light device is provided in which a thickness of the device can be made thinner than that of a direct type back light device and the width of the device can be made narrower than that of an edge light type back light device. Thus, a slim model, a narrow frame and a small size can be attained.

### BACKGROUND TECHNOLOGY OF THE INVENTION

The present invention relates to a back light device used for liquid crystal display devices.

In recent years, screen size of liquid crystal display devices has been increased. Most of the back light devices used in the large size liquid crystal display devices are what is called a direct type. In the direct types, a plurality of fluorescent lamps is arranged on the bottom of the chassis, above which a light guide plate is arranged so that the light of the fluorescent lamps can incident thereto. In the direct type back light device, a predetermined distance is necessary between fluorescent lamps and light guide plate in order to provide uniform brightness of light emitted. Thus, there were problems that a thickness of the back light device increased and a weight of the device became heavy because the number of lamps was increasing in the back light device for the large size liquid crystal display device.

To solve these problems of the back light device, the back light device called tandem type has been developed. For example, reference is made to Japanese Patent laid open application H11-288611 (Patent Document 1), Japanese Patent laid open application 2001-312916 (Patent Document 2) or Japanese Patent laid open application No. 2004-253354 (Patent Document 3). For example, in a back light device described in Patent Document 1, 2, a plurality of fluorescent lamps having a circular cross section perpendicular to the tube axis are used. Light emitted from each lamp is introduced into a light incident surface of a light guide plate provided on each of the fluorescent lamp. A reflector is provided on each of the fluorescent lamp for this purpose.

In the back light devices described, it is possible to make brightness in a light emission area uniform using relatively thin device. However, there has been a problem that it is difficult to expand a light emitting area by narrowing its peripheral portion to provide so called a narrow frame, because reflectors for guiding the light from the fluorescent lamp to the light incident surface of the light guide plate are provided at the peripheral portion of the light emitting area.

Further, in the back light device described in Patent Document 3, a plurality of fluorescent lamps having a circular cross section is also used. Band-shaped light guide plates are arranged between each fluorescent lamps and lighting curtains are provided between each fluorescent lamps and irradiated body for intercepting a part of light which is incident directly into the irradiated body from each fluorescent lamp.

In this back light device, it is possible to make brightness in light emission area uniform using relatively thin device. However, there was a problem that a structure is complicated for providing the light curtains to make the brightness uniform in the light emission area.

The present invention is made in order to overcome these conventional technical problems, and it is one of the objects to provide a back light device, which enables to realize high intensity light emission, a thin device structure and a narrow frame display.

### SUMMARY OF THE INVENTION

A back light device according to one aspect of the present invention, in which light emitted from a fluorescent lamp is introduced to a light incident surface of a light guide plate forming a flat light emission area by the light guide plate,

the back light device includes a flat fluorescent lamp of a flat cross section having a major axis and a minor axis,

wherein the light incident surface of the light guide plate is formed in the light emission area, and the major axis of the flat fluorescent lamp is arranged substantially parallel with the light incident surface.

A back light device according to another aspect of the present invention includes a flat fluorescent lamp with a flat cross section having a major axis and a minor axis, and at least two split light guide plates, wherein the flat fluorescent lamp is arranged between at least a pair of light incident surfaces formed by opposing end surfaces of the split light guide plates.

### BRIEF DESCRIPTION OF THE DRAWINGS

FIG. 1 is a diagram showing a structure of a flat type cold cathode fluorescent lamp used in an embodiment of the present invention, wherein FIG. 1(a) is a plan cross section along a tube axis of a fluorescent lamp, FIG. 1(b) is a cross section of the fluorescent lamp along a chain line A-A shown in FIG. 1(a), FIG. 1(c) is a side cross section of the fluorescent lamp and FIG. 1(d) is a cross section of the fluorescent lamp along a chain line B-B shown in FIG. 1(c).

FIG. 2 is a graph showing relative total luminous flux of the flat type cold cathode fluorescent lamp when a degree of flatness is varied.

FIG. 3 is a graph showing a range of major axis and minor axis in which a diffused positive column is generated in the flat type cold cathode fluorescent lamp.

FIG. 4 is a diagram showing a diffused state of the positive column, where FIG. 4(a) is a diagram showing a diffused state of a cold cathode fluorescent lamp having a circular cross section for a comparative example, FIG. 4(b) is a plan view showing a diffused state of the flat type cold cathode fluorescent lamp used in the embodiment of the present invention and FIG. 4(c) is also a side view showing a diffused state of the flat type cold cathode fluorescent lamp used in the embodiment of the present invention.

FIG. 5 is a graph showing a range of major axis and minor axis in which a diffusion positive column is generated when the cold cathode fluorescent lamp is applied in an edge type back light device.

FIG. 6 is a schematic diagram showing a luminance distribution of the flat type cold cathode fluorescent lamp.

FIG. 7 is a plan view of a back light device according to a first embodiment of the present invention.

FIG. 8 is a cross sectional view of the back light device shown in FIG. 7.

FIG. 9 is a cross sectional view of a back light device according to a second embodiment of the present invention.

FIG. 10 is a cross sectional view of a back light device according to a third embodiment of the present invention.

FIG. 11 is a plan view of a back light device according to a fourth embodiment of the present invention.

FIG. 12 is a cross sectional view of a back light device shown in FIG. 11.

FIG. 13 is a plan view of the backlight device according to a fifth embodiment of the present invention.

FIG. 14 is a cross sectional view of a back light device shown in FIG. 13.

FIG. 15 is an disassembled perspective view of a tandem type back light device according to a sixth embodiment of the present invention.

FIG. 16 is a view showing a structure of the flat type fluorescent lamp used in the embodiment shown in FIG. 15, where FIG. 16(a) is a cross sectional view along the tube axis, FIG. 16(b) is a cross section cut along a plane perpendicular to the tube axis.

### DETAILED DESCRIPTION OF THE INVENTION

Hereinafter embodiments of the present invention will be explained in detail referring to the figures.

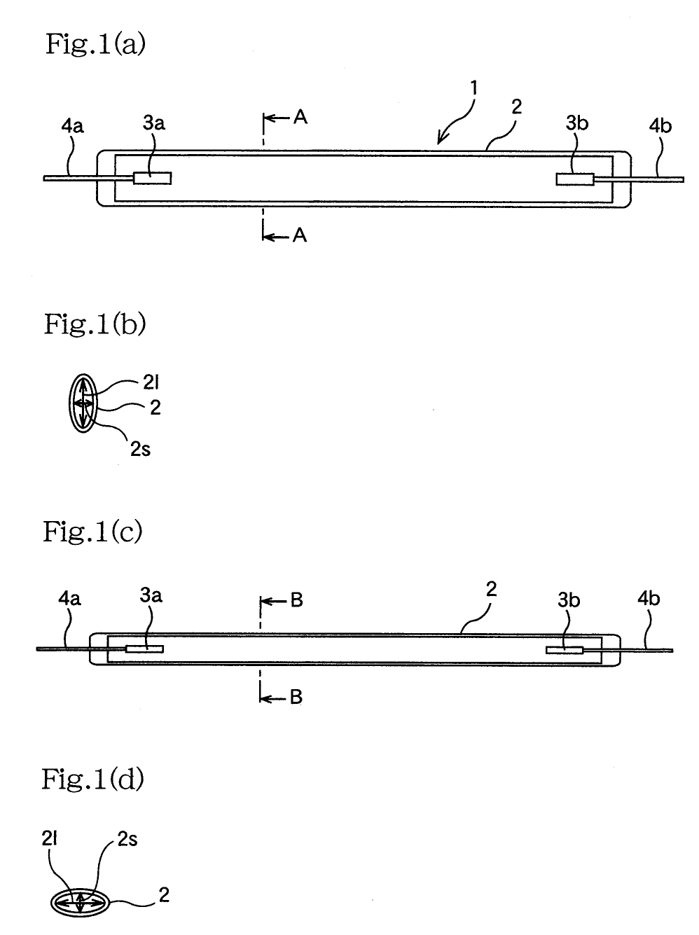

FIG. 1 is a diagram showing a structure of a flat type cold cathode fluorescent lamp used in an embodiment of the present invention, wherein FIG. 1(a) is a plan cross section along a tube axis of a fluorescent lamp, FIG. 1(b) is a cross section of the fluorescent lamp along a chain line A-A shown in FIG. 1(a), FIG. 1(c) is a side cross section of the fluorescent lamp and FIG. 1(d) is a cross section of the fluorescent lamp along a chain line B-B shown in FIG. 1(c).

A fluorescent lamp 1 has a phosphor film applied on an inner wall surface of a glass tube 2 and a rare gas with mercury encapsulated inside of the glass tube 2 with airtight. On both inner ends, electrodes 3a, 3b composed of a pair of cold cathodes are provided. Electrodes 3a, 3b are plate-shaped electrodes composed of nickel, each of which conductor wires 4a, 4b are connected. The conductor wires 4a, 4b are sealed on both ends of the glass tube 2, which fix electrodes 3a, 3b and supply them with electric power supplied from outside.

A shape of a discharge space of the glass tube 2 in a cross section perpendicular to the tube axis is defined using, for example, a major axis 2l and a minor axis 2s which are inside dimensions of the glass tube. For example, the major axis is in the range of 1.2 mm to 14.0 mm, the minor axis is in the range of 0.7 mm to 10.0 mme. That is, the shape of the cross section is not a circle but is a flat or an oval shape, in which the diffused positive column is generated. The shape of the cross section of the discharge space of the glass tube 2 may be the same along the entire length of the tube axis.

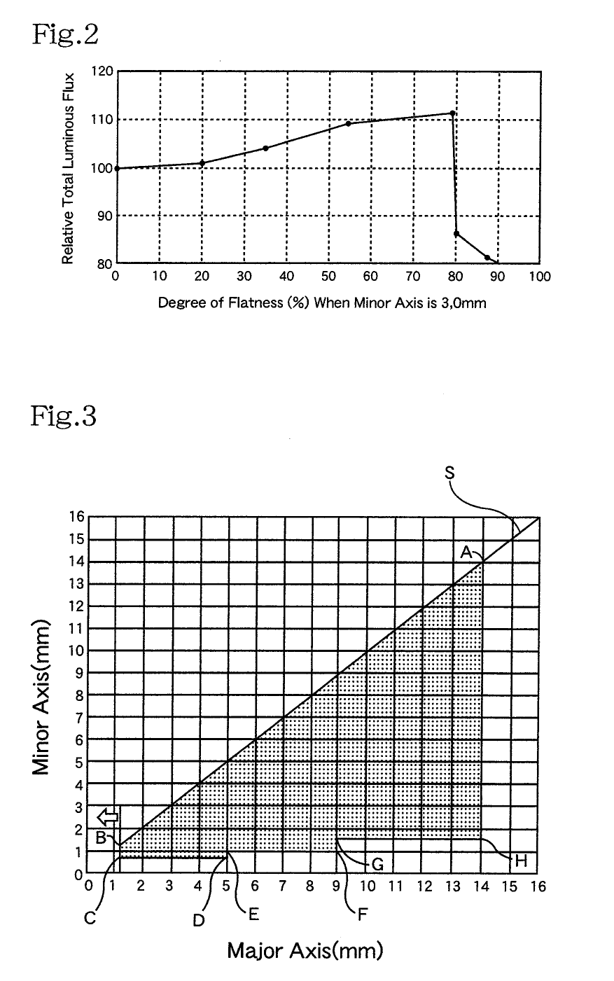

FIG. 2 is a graph showing relative total luminous flux of the flat type cold cathode fluorescent lamp when a degree of flatness is varied. Here, the degree of flatness is defined as

(major axis−minor axis)/major axis×100%.

In the graph, it is shown that minor axis 2s of the discharge space is selected as constant value such as 3.0 mm, for example, and varying major axis 2l varies the degree of flatness. In FIG. 2, the total luminous flux of a cold cathode fluorescent lamp having a circular cross section (major axis=minor axis) is defined as 100%, and relative total luminous flux of a flat type cold cathode fluorescent lamp is plotted compared with the circular one. The graph shows that when major axis is less than 14.0 mm (the degree of flatness=78.5%), namely in the region the degree of flatness is less than 78%, the longer the major axis (the larger the degree of flatness), the higher the luminous flux. However, the luminous flux shows sudden decrease when the major axis is more than 15.0 mm (the degree of flatness is more than 80%). This is because the positive column diffuses in the range where the major axis is less than 14.0 mm, however, the positive column shrinks when it is longer than 15.0 mm. Thus, light is generated at only a limited part of the phosphor film along the tube axis.

FIG. 3 is a experimentally obtained graph showing a range in which the diffused positive column is generation in a flat type cold cathode fluorescent lamp varying major axis and minor axis. In the figure, a 45° line S shows a cold cathode fluorescent lamp with a circular cross section. An inner region of a polygon ABCDEFGH including the line S as one side shows the range of major axis and minor axis in which a diffused positive column can be generated.

Namely, the range in which the diffused positive column is generated, that is, the range of the major axis in which shrunk positive column is not generated is less than 14.0 mm, as shown in FIG. 3. On the other hand, it is difficult to manufacture the lamp having the major axis less than 1.2 mm from manufacturing point of view. Therefore, it is most suitable to select the major axis in the range from 1.2 to 14.0 mm. FIG. 3 shows that the positive column is difficult to diffuse if the minor axis is 1.0 mm or less in the range of the major axis from 1.2 to 5.0 mm. FIG. 3 also shows that the positive column is difficult to diffuse if minor axis is 1.5 mm or less in the range of the major axis from 9.0 mm to 14.0 mm.

The minor axis should not be longer than 10.0 mm because thin profile model of back light unit is preferable. However it is difficult to make shorter than 0.7 mm from manufacturing point of view. Therefore, minor axis is most suitably selected in a range 0.7 mm to 10.0 mm.

As for a rare gas, a mixed gas composed of 60.0 to 99.9% of neon and balance of argon is enclosed with a pressure 6.5 to 16.0 kPa. This is a range of enclosed gas to optimize luminous efficiency in order to light a cold cathode fluorescent lamp effectively. The lamp temperature should be optimized according to the gas species enclosed and the gas pressure.

In the following embodiments, a flat cold cathode fluorescent lamp with the major axis (inner dimension) of 3.0 mm (outer dimension is 3.5 mm), the minor axis (inner dimension) of 1.6 mm (outer dimension is 2.2 mm) and the degree of flatness of 47% is used as an example. The cold cathode fluorescent lamp of comparative example has a cross section of circular shape with a diameter (inner diameter) 2.0 mm (outer dimension of 3.0 mm) in a cross section perpendicular to the tube axis. The length of glass tube is 200 mm in the embodiment and the comparative example. The mixed gas of argon and neon at a ratio of argon:neon=1:9 including mercury are enclosed in the glass tube with a charged pressure of 8 kPa.

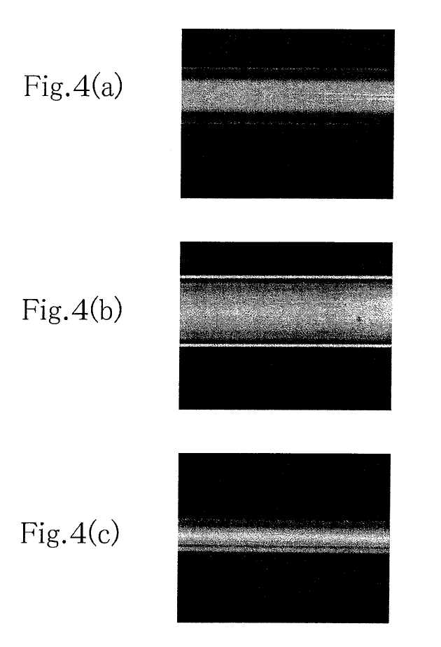

FIG. 4 is a diagram showing a diffused state of the positive column, where FIG. 4(a) is a diagram showing a diffused state of a cold cathode fluorescent lamp having a circular cross section for a comparative example, FIG. 4(b) is a plan view showing a diffused state of the flat type cold cathode fluorescent lamp used in the embodiment of the present invention and FIG. 4(c) is also a side view showing a diffused state of the flat type cold cathode fluorescent lamp used in the embodiment of the present invention. FIG. 4 shows that a diffused positive column is generated even when the shape of the cross section of the discharge space is made flat as mentioned above, and that a shrunk positive column is not generated. That is, it can be seen that the flat shape cold cathode fluorescent lamp used in the embodiment of the present invention is not much different from the cold cathode fluorescent lamp having a circular cross section which is a comparative example.

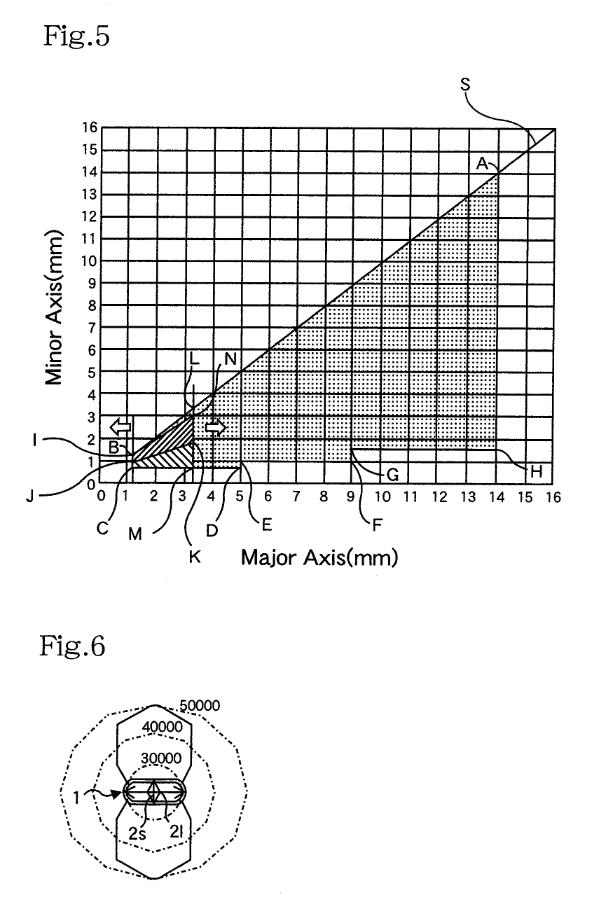

FIG. 5 is a graph showing a range of major axis and minor axis in which a diffusion positive column is generated when the cold cathode fluorescent lamp is applied in an edge type back light device. The length of the major axis of the flat type cold cathode fluorescent lamp was selected as 3.5 mm at the maximum to meet the needs for a liquid crystal display unit having a small thickness and a narrow frame. In FIG. 5, a 45° line S shows a cold cathode fluorescent lamp with a circular cross section having an inner dimension of 2.0 mm (and an outer dimension of 2.4 mm). An inner region of a polygon ABCDEFGH including the line S as one side shows the range of major axis and minor axis in which a diffused positive column can be generated. Further, an inner region of polygon JCMK shows the range in which the degree of flatness of the cold cathode fluorescent lamp is 25 to 80% and it is confirmed that luminous efficiency is improved more than 5% compared with a circular cross section fluorescent lamp in this region. Furthermore, an inner region of polygon IJKN shows the range in which the degree of flatness is 8 to 46%, and that the luminous efficiency is improved more than 10% compared with a fluorescent lamp of circular cross section in this region. Based on the experimental results shown in FIG. 5, it is found that the preferable ranges for the major axis and the minor axis of the flat type cold cathode fluorescent lamp is respectively from 1.2 to 3.5 mm and from 0.7 to 3.2 mm, and thus the degree of flatness is 8 to 80%. Namely, the luminous efficiency can be improved more than 5% compared with the cold cathode fluorescent lamp having a circular cross section, by selecting a dimension of the cross section of the flat type cold cathode fluorescent lamp used for edge type back light device in such range that the major axis of the cross section is within 1.2 to 3.5 mm, and minor axis is within 0.7 to 3.2 mm, and that the degree of flatness of a lamp is within 8 to 80%.

Further, the luminous efficiency of the cold cathode fluorescent lamp can be made optimum by enclosing a mixed gas of 60 to 99.9% neon and the balance of argon in a glass tube with a pressure ranging from 6.5 to 16.0 kPa.

The back light device according to the embodiment of the present invention is characterized in using so-called a flat type cold cathode fluorescent lamp 1 having a discharge space, in which the cross section is of a flat circular or oval shape in the incident plane of the light guide plate. In such flat type cold cathode fluorescent lamp 1, the luminance differs depending on the circumferential directions of the lamp, namely depending on the direction in the plane perpendicular to the tube axis.

An example of luminance distribution of the flat type cold cathode fluorescent lamp 1 is shown in FIG. 6. This luminance distribution has a feature that it is low in the major axis direction of the glass tube and that it is high in the minor axis direction perpendicular to the former. The luminance difference can be adjusted by changing the degree of flatness freely. FIG. 6 is a luminance distribution in which a circular lamp of outer diameter of 4 mm and inner diameter of 3 mm is produced at 45% of the degree of flatness. As shown in the figure, the luminance of a broad surface of the lamp parallel to the major axis (hereinafter called a major axis emission plane) is far greater than the luminance of a narrow surface of the lamp parallel to the minor axis (hereinafter called a minor axis emission plane), wherein the luminance ratio goes to about 1.4 to 1.6 times. Therefore, when fabricating a back light device, the flat type cold cathode fluorescent lamp is so arranged that the major axis direction of the flat glass tube 2 is nearly parallel to the light incident plane of the light guide plate. Using such structure, the luminance in a light emission area of the light guide plate at right above the fluorescent lamp 1 is suppressed and a large quantity of light can be incident into the light guide plate. As the result, a back light device can be realized with even luminance distribution and with capability of generating a large quantity of light.

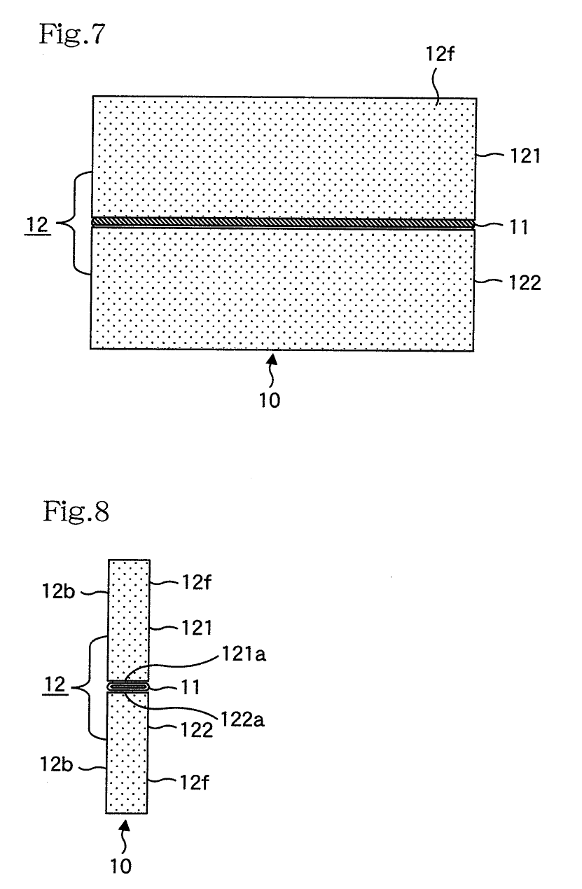

FIG. 7 is a plan view of a back light device according to a first embodiment of the present invention and FIG. 8 is the cross sectional view of the back light device shown in FIG. 7. In FIGS. 7 and 8, aback light device 10 is composed of a flat fluorescent lamp 11 and a light guide plate 12. The flat fluorescent lamp 11 is the cold cathode fluorescent lamp with a flat shaped cross section mentioned above. Here, a flat cold cathode fluorescent lamp not only of an inner electrode type but also of an outer electrode type can be used as the flat type fluorescent lamp 11. A light guide plate 12 is composed of two split guide plates 121, 122, and the flat type fluorescent lamp 11 is arranged between the opposing end planes of the two split guide plates 121, 122. The opposing end planes of the two light guide plates 121, 122 form light incident planes 121a, 122a corresponding to each light guide plates 121, 122. Each of these light incident planes 121a, 122a is formed so as to intersect nearly perpendicularly with the front surface 12f or the back surface 12b of the light guide plate 12 at. The flat fluorescent lamp 11 is arranged so that the major axis is nearly parallel with the light incident plane 121a, 122a. That is, the flat fluorescent lamp 11 is arranged so as to lie between opposing light incident planes 121a, 122a of the two split light guide plates 121, 122. Thus, a back light device of an edge light type is formed with such a structure.

In the back light device 10 according to the present embodiment, a lamp can be located in a light emission area formed on the front surface 12f of the light guide plate 12. For this reason, there is no need for the lamp to be extruded outside of the light emission area formed by the light guide plate 12. Thus, it is possible to save a space, to provide a narrow frame and to downsize the whole back light device.

Here, a fluorescent lamp having a flat circular cross section with a major axis and a minor axis such as oval, ellipse, rhombus, etc. can be widely adopted as a flat fluorescent lamp 11. The flat fluorescent lamp 11 used in the following embodiment has also the similar cross section. Further, number of flat fluorescent lamp 11 used is not limited to one for a back light device, but a plurality of flat fluorescent lamps can be used for one back light device 11 by dividing the light guide plate 12 into three or more depending on the desired luminance and by arranging each flat fluorescent lamp 11 between the opposing light incident planes of the divided light guide plate 12.

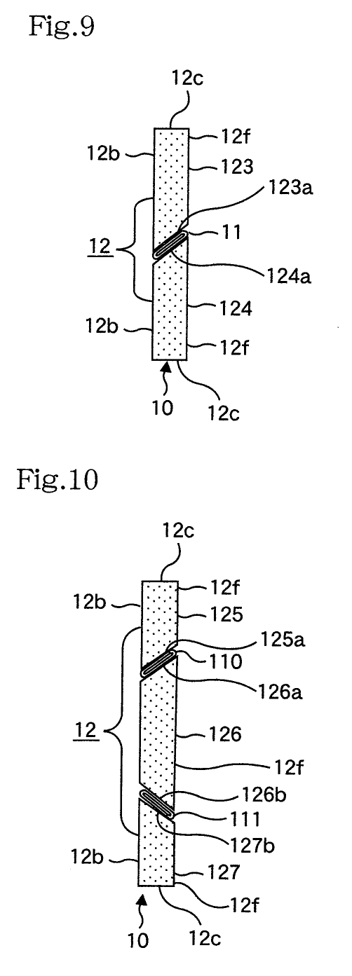

FIG. 9 is a side view of a back light device 10 according to a second embodiment of the present invention. In the embodiment, a light guide plate 12 is divided into two guide plates 123, 124 by a section diagonal to the thickness direction. That is, light incident planes 123a, 124a of the light guide planes 123, 124 are formed to be facing each other in parallel, and are formed to diagonally intersect the surface 12f of the light guide plate 12 or the back surface 12b of the light guide plate 12. The flat fluorescent lamp 11 is located between these light incident planes 123a, 124a. Also in the present embodiment, the flat fluorescent lamp 11 is arranged so as to the major axis is nearly parallel with the light incident planes 123a, 124a. Here, in FIG. 9, similar elements with those in FIGS. 7 and 8 are assigned with the same symbols.

In the back light device 10 according to the embodiment of the present, the thickness of the light guide plate 12 can be decreased thereby providing a thinner back light device when a flat fluorescent lamp 11 having the same size as the flat fluorescent lamp 11 in the first embodiment shown in FIG. 7 is used, because the flat type fluorescent lamp 11 is arranged to diagonally intersect the surface 12f or the back surface 12b of the light guide plate 12. Further, in the back light device 10 according to the embodiment of the present invention, an area of the cross section parallel to the major axis of the lamp 11 can be increased when the lamp 11 having the same size as the lamp 11 in the first embodiment shown in FIG. 7 is used. As the result, a load of an inverter for supplying power to the lamp 11 can be decreased.

FIG. 10 is a side view of a backlight device 10 according to a third embodiment of the present invention. In the embodiment, alight guide plate 12 is split into three parts. Light incident planes 125a, 126a and 126b, 127a, which are respective surfaces of three split parts, are formed to diagonally intersect with the front surface 12f or the back surface 12b of the light guide plate 12. However in the present embodiment, a pair of light incident planes 125a, 126a between the first and the second light guide plates 125, 126, and a pair of light incident planes 126b, 127a between the second and the third light guide plates 126, 127, are so formed that the intersection angles with the surface 12f of the light guide plate 12 or the back surface 12b of the light guide plate 12 are symmetrical to each other. More specifically, it is so formed that the pair of light incident planes 125a, 126a intersects with the light guide plate 12 from the surface 12f to the back surface 12b becoming lower, and the pair of light incident planes 126b, 127a intersects with the light guide plate 12 from the surface 12f to the back surface 12b becoming higher. Between the pair of light incident planes 125a, 126a, a flat fluorescent lamp 110 is arranged so as to the major axis is nearly parallel with the light incident plane 125a, 126a. And, between the pair of light incident planes 126b, 127a, a flat fluorescent lamp 111 is arranged so as to the major axis is nearly parallel with the light incident planes 126b, 127a.

In the present embodiment, using a plurality of flat fluorescent lamps 11 can increase light emission amount. A thin back light device can be attained and a uniform luminous distribution in the light emission area in front side of the light guide plate 12 can be obtained, because the plurality of flat fluorescent lamps 11 are arranged with different angles alternately with the surface 12f or back surface 12b of the light guide plate 12.

Here, number of the flat lamp 11 used is not limited to two, but a plurality of numbers can be used depending on the required intensity of illumination. In this case, the light guide plate 12 may be split into four or more, and flat fluorescent lamp 11 may be arranged between the opposing end surfaces of the split light guide plates with a symmetrical angle to adjacent flat fluorescent lamp 11.

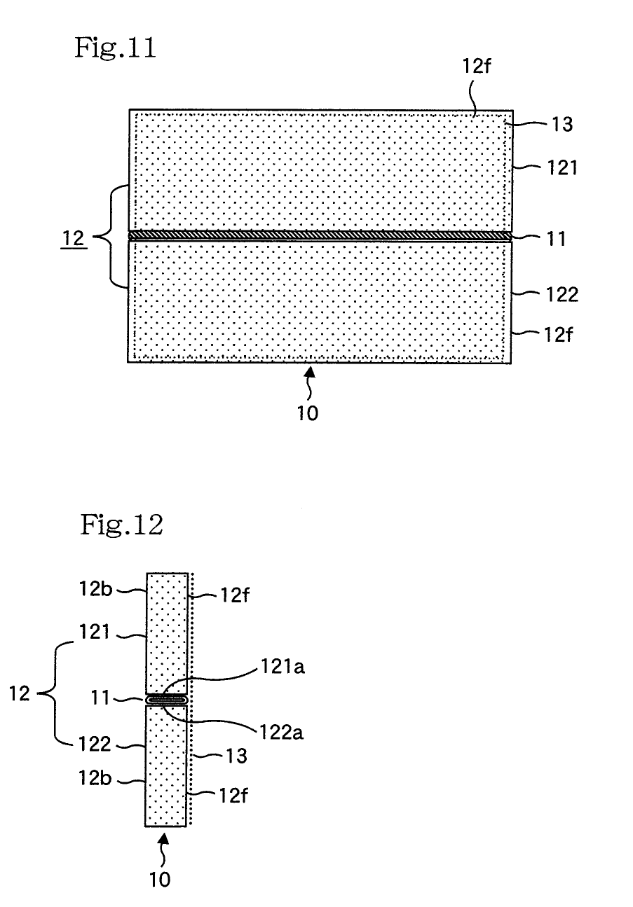

FIGS. 11 and 12 are respectively a plan view and a side view of a back light device 10 according to a fourth embodiment of the present invention. The feature of the present embodiment is that a diffusion sheet 13 is arranged on the surface 12f side of the light guide plate 12, in addition to the back light device of the first embodiment shown in FIG. 7. Using such a diffusion sheet 13, light radiated directly from the minor axis emission plane of the flat fluorescent lamp 11 to the emission area can be diffused and emitted in the light emission area with good efficiency together with the light introduced into the light guide plates 121, 122 from the light emission planes 121a, 122a. Thus light emission distribution on the light emission plane can be made uniform.

Here, the diffusion sheet 13 can also be arranged on the surface 12f side of the light guide plate in the second embodiment shown in FIG. 9 and in the third embodiment shown in FIG. 10. Thus, the light emission characteristic can be improved.

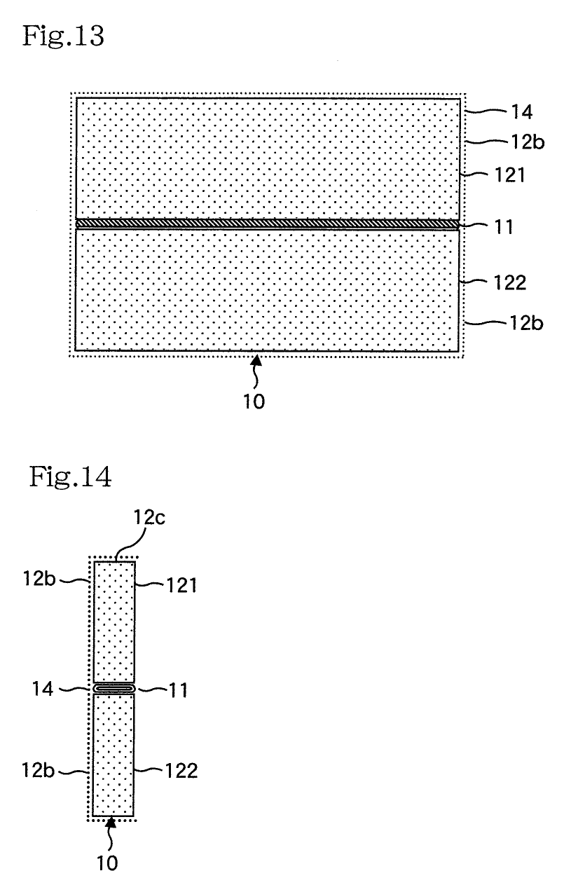

FIGS. 13 and 14 are a plan view and a side view respectively of a back light device 10 according to a fifth embodiment of the present invention. The feature of the present embodiment is that a reflector 14 is arranged on a back surface 12b and on a periphery surface 12c of the light guide plate 12, in addition to the back light device of the first embodiment shown in FIG. 7. Using such a reflector 14, light coming out of the back surface 12b or the peripheral surface 12c can be decreased, and the light from the flat fluorescent lamp 11 can be diffused in the light guide plate 12 with good efficiency. Thus, light emission characteristic can be further improved. The reflector 14 may be formed in a separate casing, in which the light guide plate 12 and the flat fluorescent lamp 11 can be contained. Otherwise, a metal evaporation film forming a reflector film etc. may be applied on the back surface 12b of the light guide plate 12.

Here, a reflector 14 can also be provided in the second embodiment shown in FIG. 9 and in the third embodiment shown in FIG. 10, so as to surround the back surface 12b and the peripheral surface 12c of the light guide plate 12, similarly to the present embodiment. With this structure, the light emission characteristic can be further improved.

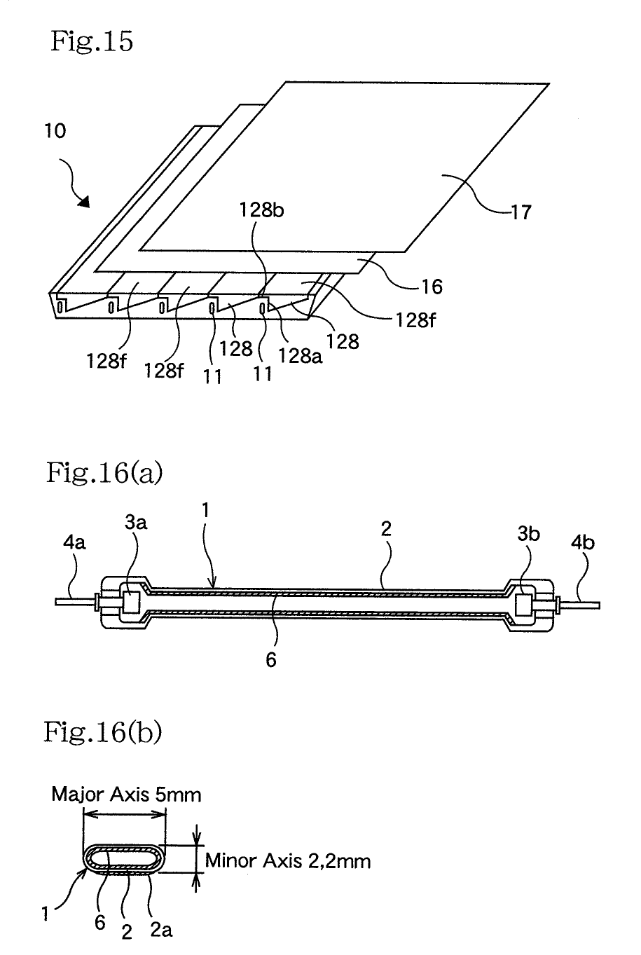

FIG. 15 shows a structure of a tandem type back light device 10 according to a sixth embodiment of the present invention and FIG. 16 shows an example of a flat fluorescent lamp 11 loaded in the back light device 10. In FIG. 15, numerals 11, 128, 16 and 17 stand for a flat fluorescent lamp, a light guide plate, a polarization plate and a diffusion sheet, respectively. A vertical light incident plane 128a and a horizontal light incident plane 128b are formed on an end portion of the light guide plate 128.

The tandem type back light device 10 of the present embodiment uses a flat fluorescent lamp 11 as a light source, which is so located that the major axis is perpendicular to the front surface 128f of the light guide plate 128. For example, in the case of a 15 inch tandem type back light device, a flat fluorescent lamp 11 with the major axis of 5 mm and the minor axis of 2.2 mm is mounted vertically so that the major axis light emitting plane is facing with the light incident plane 128a of the light guide plate 128. In the flat fluorescent lamp 11, a metal evaporated film 2a is formed on the outer surface of the glass tube 2, which is one of a pair of major axis light emitting planes and is on the opposite side to the light incident plane 128a. The metal evaporated film 2a acts as a reflecting plane, which reflects the light generated in the glass tube 2 so as to emit it from the light emitting plane facing the light incident plane 128a of the light guide plate 128. For the light directly introduced into the horizontal light incident plane 128b from the flat fluorescent lamp 11, the light guide plate 128 acts as a diffusion plate, which defuse the light directly introduced in the light guide plate 128 together with the incident light from the light incident plane 128a, so that the light from the light guide plate 128 is radiated with uniform luminance distribution on the light emission plane.

Here, the present invention is not limited to the embodiments described. Different types of flat fluorescent lamp 11 emitting light in one direction may be used instead of those described above. For example, an aperture type lamp in which a phosphor film 6 is removed on light radiation side, or a lamp in which a reflection film is formed between the phosphor film 6 and an inner wall of a glass tube 2 on opposite side to the light radiation side can be used. Further, it is needless to say that the present invention is not limited to an inner electrode type fluorescent lamp as shown in FIG. 16, but an external electrode type fluorescent lamp may be used as a flat fluorescent lamp 11.

1. A back light device, in which light emitted from a fluorescent lamp is introduced to a light incident surface of a light guide plate forming a flat light emission area by the light guide plate,
characterized in that the fluorescent lamp has a flat cross section having a major axis and a minor axis,
the light incident surface of the light guide plate is formed in the light emission area, and
the major axis of the flat fluorescent lamp is arranged substantially parallel with the light incident surface.

2. The back light device according to claim 1, wherein the light incident planes of the light guide plate are formed in parallel with each other in the light emitting area of the light guide plate, and are formed with at least a pair of light incident planes which intersect nearly perpendicular to the light emitting area of the light guide plate.

3. The back light device according to claim 2, wherein the flat fluorescent lamp is arranged between the pair of light incident planes so that the major axis is substantially parallel with the light incident plane of the light guide plate.

4. The back light device according to claim 3, wherein the flat fluorescent lamp has the major axis in the range from 1.2 mm to 14.0 mm, and the minor axis in the range from 0.7 mm to 10.0 mm, and wherein the degree of flatness of the lamp is 78.5% or lower.

5. The back light device according to claim 1, wherein the light incident planes are formed to be parallel to each other in the light emitting area of the light guide plate, and are formed with at least a pair of light incident planes which intersect diagonally with the light emitting area of the light guide plate.

6. The back light device according to claim 5, wherein the flat fluorescent lamp is arranged between the pair of light incident planes so that the major axis is substantially parallel to the light incident plane of the light guide plate.

7. The back light device according to claim 1, wherein the light incident planes are composed of a plural pairs of light incident planes which intersect diagonally with the light emitting area of the light guide plate.

8. The back light device according to claim 7, wherein the plural pairs of light incident planes are formed so that the adjacent two pairs of light incident planes intersect with the light emitting area of the light guide plate with different angles.

9. The back light device according to claim 8, wherein intersection angles of the adjacent two pairs of light incident planes intersecting with the light emitting area of the light guide plates are substantially symmetrical with respect to a plane perpendicularly intersecting the light emitting area of light guide plate.

10. The back light device according to claim 9, wherein the flat fluorescent lamp has a major axis in the range from 1.2 mm to 14.0 mm, and a minor axis in the range from 0.7 mm to 10.0 mm, and wherein the degree of flatness of a lamp is 78.5% or lower.

11. A back light device comprising:
a flat fluorescent lamp with a flat cross section having a major axis and a minor axis, lengths of which are different from each other; and
at least two split light guide plates,
wherein the flat fluorescent lamp is arranged between at least a pair of light incident planes formed by opposing edge surfaces of the split light guide plates.

12. The back light device according to claim 11, wherein the pair of light incident planes are so formed that they intersect substantially perpendicular to the light emitting area formed by the split light guide plates.

13. The back light device according to claim 12, wherein the flat fluorescent lamp is arranged between the pair of light incident planes so that the major axis is substantially parallel with the light incident plane of the light guide plate.

14. The back light device according to claim 13, wherein the flat fluorescent lamp has a major axis in the range from 1.2 mm to 14.0 mm and a minor axis in the range from 0.7 mm to 10.0 mm, and wherein the degree of flatness of a lamp is 78.5% or lower.

15. The back light device according to claim 11, wherein the pair of light incident planes are formed to be parallel to each other in the light emitting area of the light guide plate, and are formed to diagonally intersect the light emitting area of the light guide plate.

16. The back light device according to claim 15, wherein the flat fluorescent lamp is arranged between the pair of light incident planes so that the major axis is substantially parallel with the light incident plane of the light guide plate.

17. The back light device according to claim 11, wherein the light incident plane formed on the edge planes of the split light guide plates are formed by plural pairs of light incident planes diagonally intersecting the light emitting area.

18. The back light device according to claim 17, wherein the plural pairs of light incident planes are formed so that the adjacent two pairs of light incident planes intersect the light emitting area of the light guide plate at different angles.

19. The back light device according to claim 18, wherein the intersection angles at which the adjacent two pairs of light incident planes intersect the light emitting area of the light guide plates are substantially symmetrical with respect to the plane perpendicularly intersecting the light emitting area of the light guide plate.

20. The back light device according to any one of from claim 1 to claim 19, wherein a light reflecting means is formed on a light guide plate at least on the opposite side of light emitting area except the light emitting area of the light guide plate, and a diffusion plate is arranged on the light emitting area side of the light guide plate.

21. A back light device comprising:
a plurality of light guide plates each having a wedge-shaped cross section, which are arranged in tandem to each other to form a substantially horizontal light emitting plate surface;
a light incident plane which is substantially perpendicular to the light emitting plate surface formed on one end portion of the light guide plates and a light incident plane which is substantially horizontal with the light emitting plate surface;
a flat fluorescent lamp a major axis of which is arranged substantially parallel with the light incident plane of the light guide plates; and
a reflecting film formed on the major axis light emitting plane located on the opposite side of the light incident plane of a pair of major axis light emitting planes of the flat fluorescent lamp.

22. A back light device according to claim 21, wherein light of the flat fluorescent lamp directly incident into the horizontal light incident plane formed on the light guide plates is radiated from the light emitting plane together with the light of the flat fluorescent lamp directly incident into the vertical light incident plane, wherein each of the light guide plates acts as a diffusion plate.

23. A back light device according to claim 22, wherein the flat fluorescent lamp has a major axis in the range from 1.2 mm to 3.5 mm and a minor axis in the range from 0.7 mm to 3.2 mm, and wherein the degree of flatness of a lamp is selected from the range from 25.0% to 80.0%.
